(19) United States
(12) Patent Application Publication
(10) Pub. No.: US 2004/0260801 A1
(43) Pub. Date: Dec. 23, 2004

(54) Apparatus and methods for monitoring and controlling network activity using mobile communications devices

(75) Inventor: Chuang Li, Saratoga, CA (US)

Correspondence Address: LUCE, FORWARD, HAMILTON & SCRIPPS LLP, 11988 EL CAMINO REAL, SUITE 200, SAN DIEGO, CA, 92130, US

(73) Assignee: ACTIONTEC ELECTRONICS, INC., Sunnyvale, CA

(21) Appl. No.: 10/872,736

(22) Filed: Jun. 21, 2004

Related U.S. Application Data
(63) Continuation-in-part of application No. 10/464,230, filed on Jun. 17, 2003.
Application No. 10/464,230 is a continuation-in-part of application No. 10/366,028, filed on Feb. 12, 2003.

(51) Int. Cl. G06F 15/173

(52) U.S. Cl. 709/223

(57) ABSTRACT

Apparatus and methods for monitoring and controlling network activity of network appliances are provided, in which the network activity is transmitted to at least one controlling mobile communications device such as a cellular telephone or wireless telephone-enabled personal digital assistant. Internet access filtering technology is provided wherein Internet access of a monitoring network appliance may be selectively blocked based upon predefined rules, and information regarding Internet access activities, whether blocked or not, may be redirected to multiple controlling mobile communications devices for review based on other predefined rules. The predefined rules may be modified dynamically by sending a command from the controlling mobile communications device to the monitoring network appliance.

### CROSS REFERENCE TO RELATED APPLICATIONS

The present application is a continuation-in-part of U.S. patent application Ser. No. 10/464,230, filed Jun. 17, 2003, which is a continuation-in-part of U.S. patent application Ser. No. 10/366,028, filed Feb. 12, 2003.

### FIELD OF THE INVENTION

This invention relates generally to apparatus and methods for monitoring and controlling network activity. More specifically, the present invention provides apparatus and methods for monitoring and controlling of network activity by broadcasting network activity information to one or more mobile communications devices, such as a cellular telephone or wireless telephone-enabled personal digital assistant. The network activity is controlled by a set of rules that may be modified by the mobile communications device.

### BACKGROUND OF THE INVENTION

The popularity of the Internet has grown rapidly over the past several years. A decade ago, the Internet was limited to the academic and research community. Today, the Internet has grown into a communications network that reaches millions of people around the world. It provides a powerful and versatile environment for business, education, and entertainment. At any given time, massive amounts of digital information are accessed and exchanged on the Internet by millions of users worldwide with many diverse backgrounds and personalities, including children, students, educators, business men and women, and government officials, among others.

Users may access the Internet through a dial-up modem connected to existing telephone lines, or through high-speed connections including a direct connection to the Internet backbone and connections provided by T1 or T3 lines leased from telephone companies, cable modems, or DSL modems. These high-speed connections may be shared by multiple users on a local area network (“LAN”) through the use of a router, which is a device that handles all the digital information traffic between the Internet and each one of the users in the LAN.

The digital information may be accessed and exchanged through the World Wide Web (hereinafter the “web”), or by using electronic mail, file transfer protocols, or a variety of other applications, including peer-to-peer (“Pr2Pr”) file sharing systems and Instant Messaging (“IM”). Information on the web is typically viewed through a “web browser” such as Internet Explorer, available from Microsoft Corporation, of Redmond, Wash. The web browser displays multimedia compositions called “web pages” that contain text, audio, graphics, imagery and video content, as well as nearly any other type of content that may be experienced through a computer or other network appliance, such as personal and portable computers, electronic organizers, personal digital assistants (“PDAs”), and wireless telephones, among others.

Besides the web, Pr2Pr file sharing systems and IM have become increasingly popular vehicles for exchanging digital information. Pr2Pr file sharing systems enable users to connect to each other and directly access files from one another's network appliances. Such systems are mostly used for exchanging digital music or image files on the Internet. Examples include the open source systems Gnutella and Napigator.

In addition to digital files, users may also exchange messages with one another by using an IM service. An IM service is primarily used by a subscriber to “chat” with one or more other IM subscribers. Because the exchange of information is almost instantaneous, IM is quicker than ordinary electronic mail and a more effective way to communicate with other users.

To access an IM service, a user registers with an IM service provider to become a subscriber, and, after downloading and installing “IM client” software, connects to the Internet (or other appropriate data network), and enters a selected username and password to log in to an “IM server” maintained by the IM service provider. The IM server maintains a contact list or “buddy list” for each subscriber to allow the subscriber to send an instant message to any one in his/her buddy list, as long as that person, commonly referred to as a “buddy”, is also online. In addition, a subscriber may enter a “chat room” to communicate to any subscriber in the room.

Once a subscriber has logged in to the IM server, his/her presence on the network is made known to all of his/her buddies on his/her buddy list. The subscriber can then engage in typed conversations with his/her buddies and update his/her buddy list to include other subscribers that they desire to communicate with. Because of ease of use and convenient buddy lists, IM has become especially popular among children and teens. Popular IM applications include the freely-distributed ICQ, AOL Instant Messenger (“AIM”), provided by America Online, Inc., of Dulles, Va., Yahoo! Messenger, provided by Yahoo!, Inc., of Sunnyvale, Calif., and MSN Messenger, provided by Microsoft Corporation, of Redmond, Wash.

With the ease of access and distribution of digital information over the Internet, it has become increasingly important to block or filter out offensive or objectionable material that is not appropriate to all users. In particular, adult content displayed on the web may not be appropriate for children, teenagers, or employees during their work hours, and IM exchanges between children, teenagers or employees and certain users may not be acceptable to parents or employers. Furthermore, it may not be acceptable to parents or employers to have their children or employees using IM for long periods of time, or using a Pr2Pr system to exchange inappropriate files. It is therefore important to parents and employers to monitor and block exchanges on the web and other applications such as electronic mail, Pr2Pr systems, and IM.

In response to this need, a number of parental control software programs have been developed to filter out inappropriate content on the web or on other electronic media including CDs and DVDs. These filtering systems may be classified into one or a combination of four major categories: (1) rating-based systems; (2) list-based systems; (3) keyword-based systems; and (4) context-based systems.

A typical rating-based system, such as the SuperScout Web filter developed by Surf Control, Inc., of Scotts Valley, Calif., classifies web sites into different categories based on their content and enables users to define rules that govern access to the different categories. For example, a parent may define a rule allowing access to web sites belonging to an “educational” category and block access to web sites in an “adult” category. While rating-based systems allow users to rely on trusted authorities to categorize web site content, they are not always reliable because many web sites frequently change their content and their classification before the rating-based systems are updated to reflect the changes.

An alternative to using rating-based systems to filter out inappropriate content involves using list-based systems that maintain lists of inappropriate and objectionable web sites, newsgroups, and chat rooms that may be selected by users for blocking, or using keyword-based systems that filter content based on the presence of inappropriate or offending keywords or phrases. However, list-based systems, such as Net Nanny, developed by Net Nanny Software International, Inc., of Vancouver, BC, Cyber Patrol, developed by Surf Control, Inc., of Scotts Valley, Calif., and Cyber Sitter, developed by Solid Oak Software, Inc., of Santa Barbara, Calif., are also unreliable because new web sites, newsgroups, and chat rooms are constantly appearing, and the lists, even when updated, are obsolete as soon as they are released.

In addition, keyword-based systems, such as the Cyber Sentinel system developed by Security Software Systems, of Sugar Grove, Ill., also produce poor results since they are likely to block sites that should not be blocked while letting many inappropriate sites pass through unblocked. Because they are based on text recognition, keyword-based systems are unable to block offensive or inappropriate pictures.

To make keyword-based systems more effective, context-based systems, such as the I-Gear web filter developed by Symantec Corporation, of Cupertino, Calif., have been developed to perform a contextual analysis of a web site to be blocked. The I-Gear system employs context-sensitive filtering based on a review of the relationship and proximity of certain inappropriate words to other words on the web site. While I-Gear and other context-based systems are more effective than individual keyword-based systems, they lack the ability to filter electronic content other than text on web pages, and therefore are not guaranteed to block a site containing inappropriate pictures.

In addition to unreliability in blocking unwanted web site material, all of the above mentioned filtering systems do not monitor content that is exchanged through non web-based applications, such as electronic mail and IM. Software monitoring programs, such as Online Recorder, provided by Morrow International, Inc., of Canton, Ohio, and ChatNanny, provided by Tybee Software, Inc., monitor online activity in instant messages, chat rooms, electronic mail, etc., and record the monitored information for later viewing. For example, a parent may install a monitoring program on his children's machines to record his children's online activity, including their IM usernames and passwords, and later access a password protected information viewer provided with the monitoring software to view a record of his children's online activity on any given day.

Although these programs give parents or employers accurate information of the content of messages exchanged via IM or electronic mail and the location of web sites visited, they can only produce a historical account of the users' activity. In addition, they provide no mechanism to prevent the unwanted activity from occurring. The monitoring programs may be used solely for monitoring purposes and are not able to perform any actions on the monitored user, such as blocking the user from seeing a particular web site. Furthermore, in order for these monitoring programs and other web-filtering systems to be effective, they must be installed on every network appliance that is to be monitored.

Besides the above mentioned software monitoring programs, some hardware products, such as the RP614 router, provided by NETGEAR, Inc., of Santa Clara, Calif., have limited monitoring capabilities. The RP614 router may be configured to provide reports of online activity for every appliance in a LAN and also limit access to predetermined web sites. However, this router does not provide real-time monitoring functionality and its ability to prevent unwanted material from being accessed is limited to the predetermined web sites. Additionally, the user must log on to the router in order to obtain activity reports, and therefore is not able to remotely monitor network activity from a device outside the LAN.

Network activity may be monitored remotely with the use of remote network management software, including NetOp, provided by Danware Data A/S, of Birkerod, Denmark, pcAnywhere, provided by Symantec Corporation, of Cupertino, Calif., and GoToMyPC, provided by Expertcity, of Santa Barbara, Calif. These applications enable users to view the screen and control the keyboard, mouse, files, resident software, and network resources of any remote computer, regardless of its location. For example, a parent may use one of these applications to monitor his children's computers at home while the parent is away on a business trip and an IT employee at a company may use one of these applications to help a company's employee solve a problem, install a software, or perform other actions on the employee's laptop computer while the employee is away from his office. In short, these applications enable users to monitor and control a computer or network remotely and to perform all actions as though they were there in person.

The drawback is that these applications may be slow and generate unnecessary traffic when used to monitor network activity of a remote computer. Since most of these applications transmit the image of the screen of the remote computer being monitored instead of transmitting the network traffic, i.e., packets, generated by the activity, the unnecessary traffic generated is in the form of screen backgrounds and other graphic displays, local application and other pop-up windows, error messages, etc. Transmitting this unnecessary traffic may result in delays, which may ultimately prevent the activity from being monitored in real-time.

Additionally, these applications may require the user monitoring the remote computer to send a request to a server or to the remote computer every time the user desires to view information pertaining to activities in the remote computer. That is, these applications may not be used to monitor remote network activity in real-time without user intervention. Further, these applications may not be used to enable a device to monitor the activity of another remote device without user intervention.

In view of the foregoing, it would be desirable to provide apparatus and methods for monitoring and controlling of local network activity.

It further would be desirable to provide apparatus and methods by which a monitoring network appliance monitors its network activity and transmits information regarding that network activity to at least one controlling user and controlling mobile communications device without user intervention.

It also would be desirable to provide apparatus and methods by which a monitoring network appliance monitors its network activity, and communicates information regarding that monitoring to a controlling user and controlling mobile communications device and responds to commands from the mobile device to perform actions that control the network activity of the monitoring network appliance.

### BRIEF SUMMARY OF THE INVENTION

In view of the foregoing, it is an object of the present invention to provide apparatus and methods for monitoring and controlling local network activity without user intervention.

It is a further object of the present invention to provide apparatus and methods by which a monitoring network appliance monitors its network activity and transmits information regarding that network activity to at least one controlling user and controlling mobile communications device without user intervention.

It is also an object of the present invention to provide apparatus and methods by which a monitoring network appliance monitors its network activity, communicates information about that monitoring to at least one controlling user and controlling mobile communications device and responds to commands from the controlling user or controlling mobile communications device to perform actions that control the network activity of the monitoring network appliance.

These and other objects of the present invention are accomplished by providing apparatus and methods by which a network appliance monitors its network activity and transmits information about that network activity to at least one controlling user and controlling mobile communications device without user intervention.

The invention employs Internet access filtering technology so that Internet access of a monitoring network appliance may be selectively blocked based on predefined rules, and/or Internet access activities, whether blocked or not, may be redirected to one or more controlling mobile communications devices based on another set of predefined rules. The predefined rules preferably may be modified dynamically by sending a command from the controlling mobile communications device to the monitoring network appliance.

The network activity information may correspond to the network activity of a network appliance directly connected to the Internet or the network activity of a network appliance in a local area network (“LAN”) connected to the Internet by means of a network gateway, which is an embedded device that acts as an entrance to another network, such as a router, a modem, switch, hub, bridge, or other embedded device. In both cases, the network activity information, or excerpts of the network activity information, may be broadcast to one or more controlling users or mobile communications devices that desire to monitor and control the network activity. As used in this specification, an “excerpt” comprises information that is extracted from data packet transmitted to or from the Internet by the MNA, and includes a URL, a snippet of text or image, etc., as may be determined by the controlling user to be relevant to the monitoring purposes of the system.

The network appliances or the network gateway in the LAN to be monitored are hereinafter interchangeably referred to as monitoring network appliances (“MNAs”). Remote devices that receive network activity information from MNAs are hereinafter interchangeably referred to as controlling mobile communications devices (“MCDs”). The MCDs are in communication with a mobile communications server. The MCDs receive information from and transmit information to the mobile communications server. In a preferred embodiment of the present invention, the MCDs comprise one or more mobile communications devices, such as cellular telephones or personal digital assistants (PDAs) having wireless telephone capabilities.

A MNA preferably includes a monitoring engine, a reporting engine and a command set interpreter. Information passed between the MNAs and MCDs preferably includes short message service (SMS), an electronic mail protocol (such as SMTP) or client-server transmission.

The monitoring engine is a program capable of reading the contents of each network packet passed between the MNA and the Internet and determining the network activity represented in the packets. The monitoring engine also may be configured to send network activity information, including an excerpt of the MNA screen display, to one or more MCDs, which then provide instructions to the MNA regarding handling of the incoming and outgoing network activities of the MNA. According to one embodiment of the present invention, only a portion of the text and none of any pictures or images displayed on a web page is transmitted to the MCD. This compensates for any MCDs that may have a smaller display screen.

According to one embodiment of the present invention, the information sent to the MCD may be in the form of a menu. The information may be categorized and associated with options that may be selected by the user of the MCD. For example, the information may be presented in a menu such as 1) Games; 2) IM threads; 3) Sites Visited. The user may select one of the menu options to be presented with additional information regarding that category. For example, if the MCD is a mobile phone, the user may press the 3 key on the mobile phone keypad to receive more information regarding web sites visited by the device being monitored. Other types of input mechanisms such as a touch-screen, voice recognition software, etc. may be used. The information may provide a list of web sites accessed, time of access, duration of access, etc.

The reporting engine records network activity information of the MNA into logs and sends the logs to the MCD. The command set interpreter is a program that receives and executes commands sent by the MCD that control operation or the connection status of the MNA. The commands may be input as dual-tone-multi-frequency (DTMF) sounds, text messages or other known input. Additionally, a simple command string mechanism, which emulates a telephone voice prompt message system providing easy memorization and control, may be used.

A MCD preferably includes a display engine and command set. The display engine displays the network activity information received from the monitoring engine and/or reporting engine of the MNA. The MCD may passively analyze the information received from the MNA without performing any action or may direct the MNA to perform an action using a command selected from a command set, e.g., to direct the MNA to block a particular web site or chat room. The command set has a list of commands that a MCD may use to direct the MNA to perform an action that control the network activity of the MNA, such as a “block” command to block the MNA from accessing a web site or chat room, a “disconnect” command to disconnect the MNA from the Internet, and a “time out” command to limit the time the MNA is connected to the Internet, among others.

In accordance with the principles of the present invention, a single MCD may control one or more MNAs, and conversely, a single MNA may send network information to one or more MCDs.

In accordance with another aspect of the present invention, the monitoring engine of the MNA comprises a packet analyzer. Generally, the packet analyzer is a program that intercepts traffic to and from the MNA, identifies the type of packet, and then analyzes and processes the packet before returning the packet to the traffic flow. The packet analyzer employed in the MNA preferably identifies the packet by its type, e.g., HTTP, instant message, etc., by comparing the packet against a predefined set of templates that specify how the packet is configured.

Once the protocol of the packet is determined, the packet analyzer analyzes the packet against defined rules to determine whether and how to modify the packet before returning it to the traffic flow as well as to determine whether and how to generate an excerpt of the packet to send to the MCD. For example, for a packet going from MNA to the Internet, if the packet is determined to be an URL or an instant message in the approved list, the packet will be sent to the destination web site or the instant message server. The same packet also will be analyzed to determine whether an excerpt of the packet should be sent to the MCD for display.

On the other hand, if the packet is determined to contain the URL of a website listed on a list of blocked sites, contain an instant message to be sent to a non-approved receiver, or contain certain information that is not approved to be sent out, the packet will be blocked before it is sent to the Internet. Again the blocked packet also will be analyzed to determine whether an excerpt of the packet should be sent to the MCD for display.

For the packet incoming from Internet to the MNA, if the packet is determined to contain an URL or an instant message in the approved list or not in the blocked list, the packet will be passed to the MNA. If the packet is determined to contain an URL or an instant message not in the approved list, or contains information not allowed to be received by the MNA, the packet will be blocked. The incoming packet, whether it is blocked or is passed to the MNA, will be checked against a predefined rule to determine if an excerpt of the incoming packet should be sent to the MCD for display.

Advantageously, the systems and methods of the present invention enable one or more MNAs to monitor their own network activity in real-time, communicate monitoring information to one or more MCDs and respond to commands from the MCDs to perform actions that control the network activity of the one or more MNAs.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is a schematic diagram of an exemplary embodiment of the network environment in which the present invention operates;

FIG. 2 is a schematic diagram of components of a preferred embodiment of the present invention;

FIG. 3 is a schematic diagram illustrating how a data packet is screened and analyzed by the packet analyzer in the monitoring network appliance;

FIG. 4 is a flow chart for performing an action based on monitored network information; and

FIG. 5 is an illustrative diagram of a list of commands in the command set.

### DETAILED DESCRIPTION

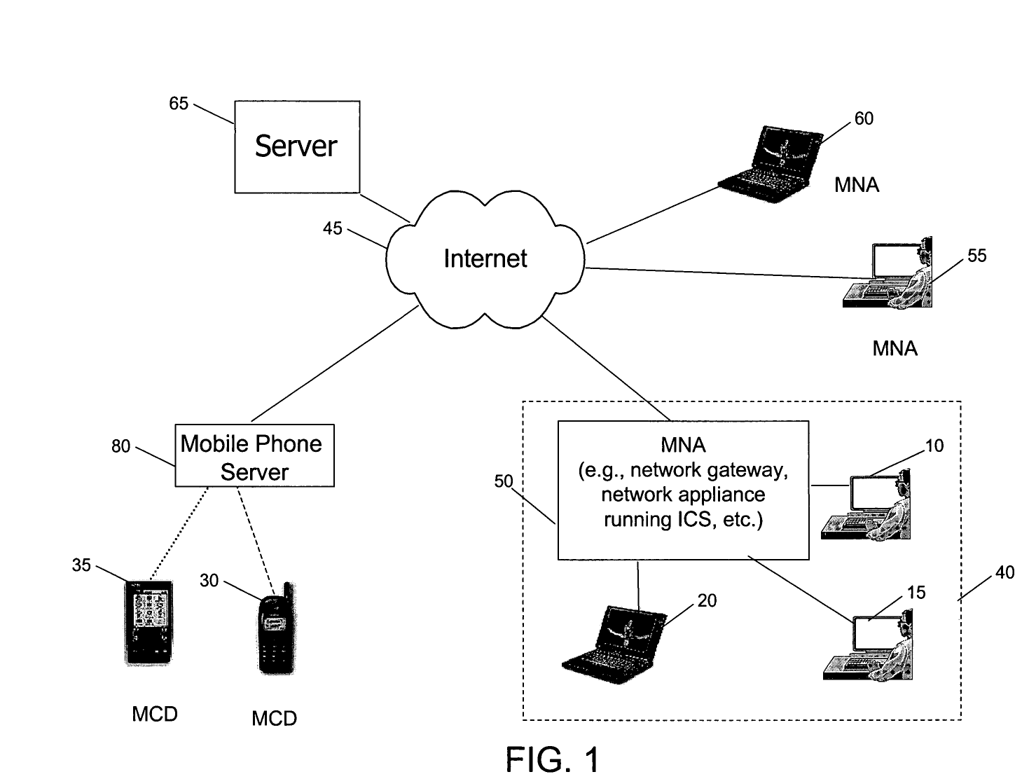

Referring now to FIG. 1, a schematic diagram of an exemplary embodiment of the network environment in which the present invention operates is described.

Network appliances 10, 15 and 20 form local area network (“LAN”) 40 that connects to Internet 45 through MNA 50. MNA 50 is a network appliance equipped with a monitoring engine, which is a program capable of reading the contents of each network packet transmitted from/to LAN 40 to/from Internet 45 and collecting status information regarding the activity of the network appliances in LAN 40. MNA 50 may be a network gateway that acts as an entrance to another network, such as a router, a modem, switch, hub, bridge, or other embedded device. MNA 50 may also include a combination of network entrance devices, such as a router and a high-speed modem, including a DSL modem and a cable modem, among others. The router may be a stand-alone device or integrated into the high-speed modem. In addition, MNA 50 may be a network appliance running an Internet Connection Sharing (“ICS”) routine for sharing a single connection to Internet 45 between network appliances 10, 15 and 20.

Network appliances 55 and 60, illustratively desktop and portable computers, respectively, are directly connected to Internet 45. Each of network appliances 55 and 60 includes a client software application that performs the functions of the MNA of the present invention, as described hereinbelow.

Information collected by MNAs 50, 55 and 60 regarding the network activity of appliances 10, 15, 20, 55 and 60 is transmitted to server 65, which may be a mail server or data server, for communication with one or more MCDs. MCDs illustratively include mobile communications devices, such as cellular telephone 30 and personal digital assistant 35, via mobile phone server 80. MCDs may include, however, any device capable of receiving information using short message service (SMS).

In accordance with the principles of the present invention, MNA 50, and MNA client applications on network appliances 55 and 60, preferably comprise a packet analyzer that applies a series of predefined rules to control operation of the MNA, e.g., by blocking outbound traffic to prohibited websites or blocking inbound traffic from non-approved sources. A controlling user accessing a MCD may passively analyze the information received from MNAs 50, 55 and 60 to oversee activity in network appliances 10, 15, 20, 55 and 60. Alternatively, a controlling user may analyze the information received from the MNAs to determine whether any immediate or future action to control network activity in LAN 40 or network appliances 55 and 60 is to be taken. If so, the controlling user may direct the corresponding MNA to perform an action to control network activity by sending a message to the MNA with a command to be executed.

For example, MCD cellular telephone 30 may be used by a parent to monitor activity in network appliance 15 used by his children to access Internet 45. In another example, LAN 40 may be a business network and MCD 35 may be accessible by an IT employee to oversee the online activity of all employees working on network appliances in LAN 40.

According to one embodiment of the present invention, the MCD functions to control activities performed by a device being monitored as well as monitoring the activities, web sites visited, and other information processed by the device being monitored. This eliminates a need to have a second device, for example, a computer, monitoring the activities performed by the device. A second device may be used to maintain the privacy of a user monitoring a particular device.

The present invention eliminates the need for a second device by associating a unique identifier, for example, a mobile phone number, to a particular user. The invention maintains an association between a device being monitored and a MCD. The device being monitored may be identified using, for example, an Internet Protocol (IP) address. The invention associates an IP address with a mobile phone number. Therefore, when a command is received to control a particular device, the invention determines the mobile phone number associated with the device from which the command was sent and the device to be controlled using the IP address associated with that mobile phone number. In this manner, monitoring is more secure and privacy is increased because a user of an MCD does not need to access an intermediate device that may be accessible to others. According to one embodiment, the invention may associate a device to be monitored with a mobile phone number during a registration process in which a user enrolls in a monitoring service.

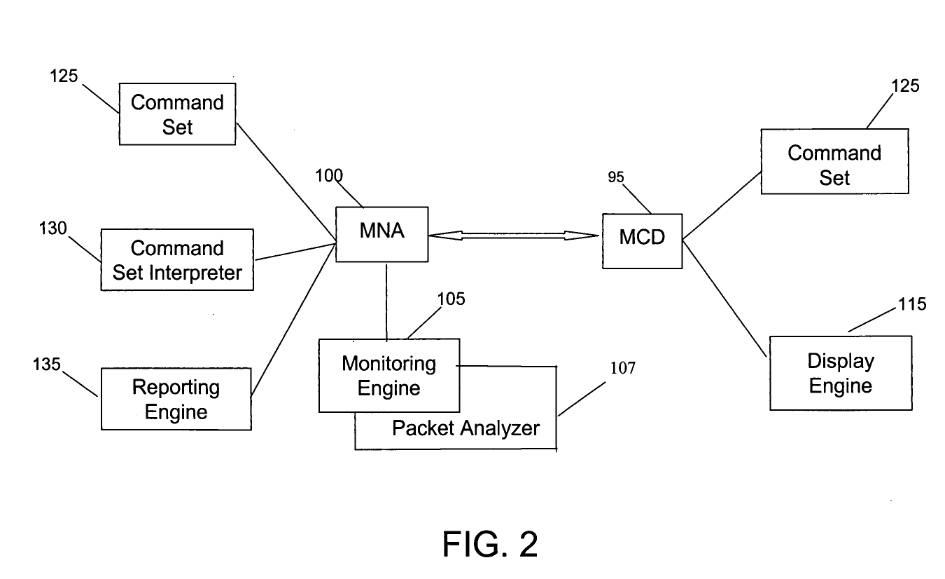

Referring now to FIG. 2, a schematic diagram of the software components used in a preferred embodiment of the present invention is described. MNA 100 preferably includes: (1) monitoring engine 105 having packet analyzer 107; (2) command set 125; (3) command set interpreter 130; and (4) reporting engine 135. MCD 95 preferably includes: (1) command set 125 and (2) display engine 115 that displays the network activity information retrieved from server 65.

Monitoring engine 105 is a program embedded in MNA 100 for reading the contents of each network packet transmitted between MNA 100 and Internet 45. Monitoring engine 105 determines the network activity represented in the packets, such as URLs accessed, chat rooms visited, e-mails sent and received, and instant messaging (“IM”) sessions, among others. Monitoring engine 105 of MNA 100 preferably includes packet analyzer 107. Packet analyzer 107 first analyzes incoming packets to determine the protocol, and thus configuration of the packet, and then applies a predefined set of rules for filtering or modifying the packet before returning the packet to the traffic flow.

Alternatively or in addition, packet analyzer 107 may apply another set of predefined rules to determine whether particular network activity should be transmitted to one or more mobile communications devices. For example, packet analyzer may determine that a particular data packet contains unsuitable contents, e.g., content or a sexual or violent nature, or in a corporate environment, that reflect sensitive business information. In such a case, the presence of such content may select the network activity as appropriate for transmission to one or more MCDs for review.

In a preferred embodiment, MNA 100 communicates with MCD 95 via two servers, a data server and a mobile phone server. It should be understood by one of ordinary skill in the art that these two servers can physically reside in one server.

Of particular interest is the situation where MCD 95 is a mobile communications device, such as a cellular telephone or wireless telephone-enabled personal digital assistant. In this case, server 65 functions as a mail server, and receives and stores transmissions from MNA 100 until MCD 95 logs in to receive the messages. Due to the limited display capabilities of commercially available cell phones, the messages from MNA 100 may comprise excerpts of the text of the web pages visited by network appliance 15, 20, 55 or 60, rather than, for example, the entire web page. Server 65 also receives and stores transmissions from MCD 95, e.g., control commands, destined for delivery to MNA 100.

MNA 100 may be programmed to log onto server 65 periodically to look for messages from MCD 95, or may be programmed to do so more frequently depending upon the nature of the transmissions being sent from MNA 100. For example, if the packet analyzer detects network activity that meets certain of the predefined rules with respect to prohibited content, MNA 100 may send a message informing MCD 95 of the activity, and then frequently check server 65 for command messages from MCD 95 regarding how the MNA should respond to the situation.

Command set interpreter 130 is provided in MNA 100 to receive commands in command set 125 sent by MCD 95 and to execute those commands. Specifically, after receiving the information from MNA 100, MCD 95 may direct MNA 100 to perform actions to control the network activity monitored by MNA 100, such as blocking access to a given web site or chat room. MCD 95 directs MNA 100 to perform an action by using a command in command set 125 embedded in MNA 100. The commands are relayed to MNA 100 depending on its IP address, as described above.

Command set 125 is a list of commands that MCD 95 may use to direct MNA 100 to perform an action to control the network activity monitored by MNA 100, such as a “block” command to block MNA 100 from accessing a web site or chat room, a “disconnect” command to disconnect MNA 100 from Internet 45, and a “time out” command to limit the time MNA 100 is connected to Internet 45, among others.

Reporting engine 135 optionally is provided in MNA 100 to record network activity information into logs and send the logs to MCD 95. The logs may be transmitted to MCD 95 by posting on a server with a secure mechanism enforced by the matching IP address and mobile phone number. The logs also may be periodically pulled by MCD 95 by dialing to the server database.

Still referring to FIG. 2, MCD 95 has display engine 115 and command set 125. Display engine 115 of MCD 95 enables the MCD to display network activity information received from the MNA. Command set 125 consists of the commands that MCD 95 may direct to MNA 100 to control operation of the MNA.

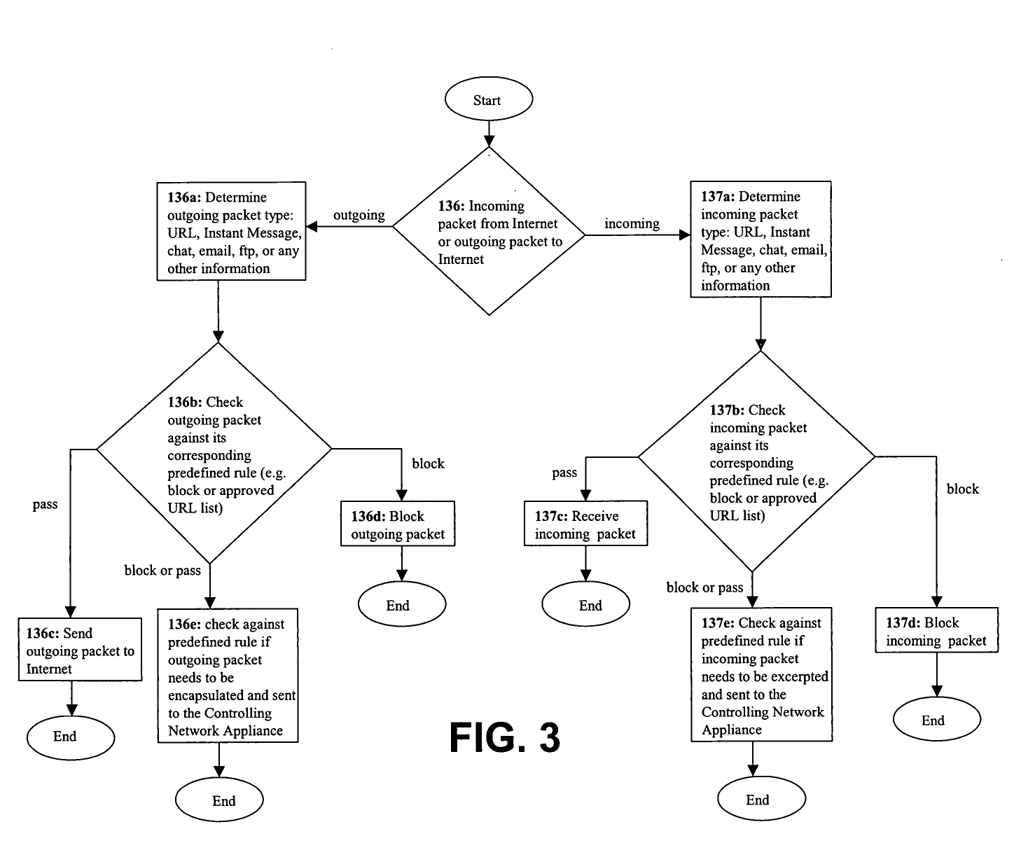

Referring now to FIG. 3, the process of analyzing incoming packets from the Internet and outgoing packets to the Internet in the MNA is described. Packet analyzer 107 determines if the packet is incoming from the Internet (inbound) or outgoing to the Internet (outbound) at step 136. For an outbound packet, packet analyzer 107 first determines the packet type, e.g., the URL of a web site, an instant message, a CHAT room discussion, an email, a FTP file upload, or any other information at step 136a.

At step 136b, each outbound packet is checked against a set of predefined rules, such as an approved list or a blocked list, based on its packet type. If the packet passes the predefined rule, it is sent to the Internet at step 136c. If the packet does not pass the applicable predefined rule, e.g., it is destined for an address on the “blocked” list or not in the approved list, the outbound packet is not sent to the Internet at step 136d. At step 136e, based on another predefined rule, the outbound packet, whether it is being blocked or passed to be sent to the Internet, may be excerpted and sent to the MCD for review.

At step 137a, for an inbound packet to MNA, packet analyzer 107 first determines the packet type. At step 137b, each incoming packet is checked against a set of predefined rules (such as an approved list or a blocked list) based on its packet type. If the packet passes the predefined rule for the corresponding packet type, the inbound packet is received and forwarded to normal traffic flow, at step 137c. If the packet does not pass the predefined rule (e.g., it is in the blocked list or not in the approved list), the inbound packet is blocked from receipt by the MNA, at step 137d. At step 137e, based on yet another predefined rule, the inbound packet, whether it is blocked or passed to the normal traffic flow, may be excerpted and sent to the MCD for monitoring.

In addition, MNA 100 records network activity into logs throughout the steps illustrated in FIG. 3 using reporting engine 135. The logs are transmitted to MCD 95 via electronic mail, by posting on a secure web site accessed only by MCD 95 with a security key, or transmitted by other means, such as via voice mail or fax.

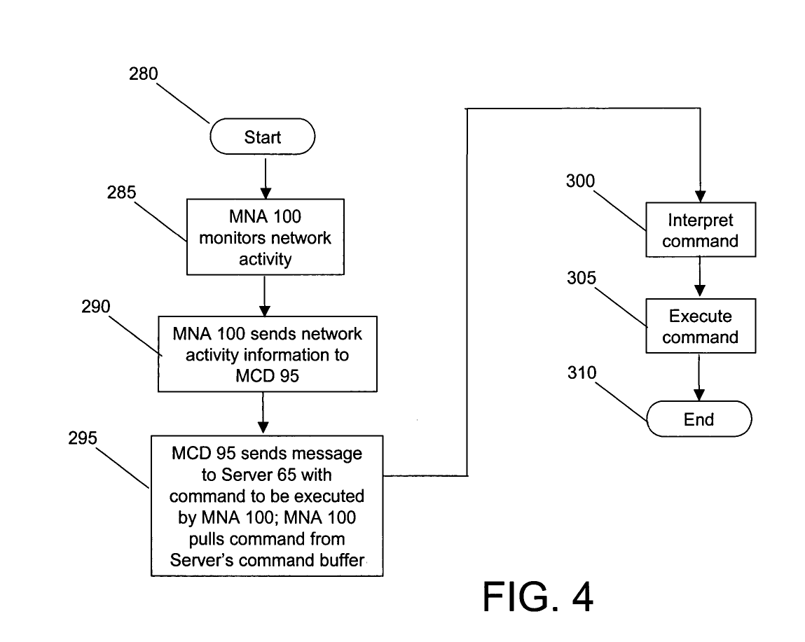

Referring now to FIG. 4, a flow chart for performing an action based on monitored network information is described. MNA 100 monitors the network activity at step 285, that is, MNA 100 runs monitoring engine 105 to read all network packets from/to MNA 100 to/from Internet 45 and determines the network activity represented in the packets. At step 290, MNA 100 transmits the network activity information to MCD 95 via server 65 (see FIG. 1).

Upon receiving and analyzing the information, MCD 95 sends a message to MNA 100, via server 65, with a command to be executed (step 295). Lastly, the command is interpreted (step 300) and executed (step 305) by MNA 100 using command set interpreter 130. For example, MNA 100 may block access to a given server, or may interrupt its Internet connection for a limited period of time.

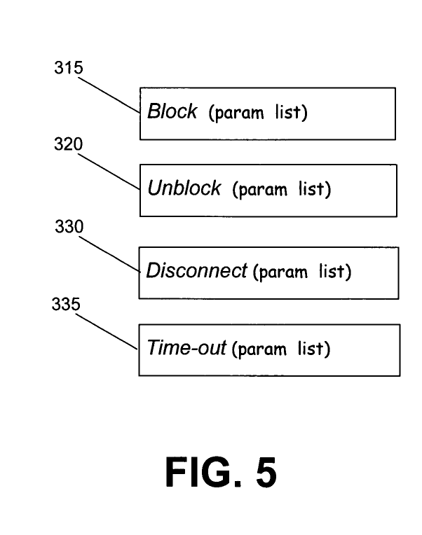

Referring now to FIG. 5, an illustrative diagram of a list of commands in the command set is described. Each command in command set 125 has a command name and a list of parameters corresponding to the command. Block command 315 is a command for blocking MNA 100 from performing a given network activity, such as accessing a web site, chat room, or newsgroup, or from viewing an image or audio file, or from running a given network service, such as IM. Block command 315 has a parameter list to specify the activity or service to be blocked. Unblock command 320 is a command for unblocking an activity or service previously blocked by block command 315.

Disconnect command 330 is a command for disconnecting MNA 100 to Internet 45. Similar to block command 315, disconnect command 330 has a parameter list to specify when MNA 100 is to be disconnected from Internet 45.

Command set 125 may also have command 335 to time-out MNA 100 from using Internet 45 or from using a web browser, IM, or other application. The parameter list associated with time-out command 335 may include the activity or service to be timed-out, among other parameters. It should be understood by one skilled in the art that command set 125 may include additional commands not shown in FIG. 5.

Although particular embodiments of the present invention have been described above in detail, it will be understood that this description is merely for purposes of illustration. Further variations will be apparent to one skilled in the art in light of this disclosure and are intended to fall within the scope of the appended claims.

What is claimed is:

1. A method for monitoring and controlling network activity using a mobile communications device, the method comprising:
analyzing network activity to collect network activity information associated with a monitoring network appliance without user intervention;
screening the network activity against a first predefined set of rules;
if required by the first predefined set of rules, modifying the network activity in accordance with the first predefined set of rules; and
selectively transmitting the network activity information to a mobile communications device.

2. The method of claim 1, further comprising:
screening the network activity against a second set of the predefined set of rules to determine whether to selectively transmit the network activity information to the mobile communications device.

3. The method of claim 1, further comprising sending a command from the mobile communications device to the monitoring network appliance to control the network activity of the monitoring network appliance.

4. The method of claim 3 wherein sending a command from the mobile communications device to the monitoring network appliance comprises updating the first predefined set of rules.

5. The method of claim 1 wherein the network activity corresponds to excerpts of data packets received by the monitoring network appliance, the method further comprising identifying an applicable protocol of the data packets.

6. The method of claim 3, wherein sending a command from the mobile communications device to the monitoring network appliance to control the network activity of the monitoring network appliance comprises sending one or more of: a block command; an unblock command; a disconnect command; and a time-out command.

7. The method of claim 3, further comprising interpreting and executing the command in the monitoring network appliance to control the network activity of the monitoring network appliance.

8. The method of claim 1, further comprising:
recording the network activity information into logs; and
transmitting the logs to the mobile communications device.

9. The method of claim 1, further comprising displaying the network activity information in the mobile communications device.

10. The method of claim 1, wherein the network activity information is transmitted to two or more mobile communications devices.

11. A method for monitoring and controlling network activity using a mobile communications device, the method comprising:
analyzing network activity to collect network activity information associated with a monitoring network appliance without user intervention and in real-time;
screening the network activity against a first predefined set of rules to determine whether to selectively transmit the network activity information to the mobile communications device; and
if required by the first predefined set of rules, transmitting an excerpt of the network activity information to a mobile communications device.

12. The method of claim 11 further comprising sending a command from the mobile communications device to the monitoring network appliance to control the network activity of the monitoring network appliance.

13. The method of claim 11, wherein screening network activity comprises screening network activity to determine a content of the network activity.

14. The method of claim 11, wherein screening network activity comprises screening network activity to determine a type of the network activity.

15. The method of claim 12, wherein sending a command from the mobile communications device to the monitoring network appliance to control the network activity of the monitoring network appliance comprises sending one or more of: a block command; an unblock command; a disconnect command; and a time-out command.

16. The method of claim 12 wherein sending a command from the mobile communications device to the monitoring network appliance updates the first predefined set of rules in the monitoring network appliance.

17. The method of claim 11 wherein the network activity corresponds to data packets received from Internet and/or transmitted to the Internet by the monitoring network appliance, the method further comprising identifying an applicable protocol of the data packets.

18. The method of claim 12, further comprising interpreting and executing the command in the monitoring network appliance to control the network activity of the monitoring network appliance.

19. The method of claim 11, further comprising:
recording the network activity information into logs; and
transmitting the logs to the mobile communications device.

20. The method of claim 11, further comprising displaying the excerpt of the network activity information in the mobile communications device.

21. The method of claim 11, wherein the network activity comprises data packets, the method further comprising:
screening the data packets against a second predefined set of rules; and
if required by the second predefined set of rules, modifying the data packets in accordance with the second predefined set of rules.

22. The method of claim 11, wherein the network activity information is transmitted to two or more mobile communications devices.

23. A monitoring network appliance for monitoring and controlling network activity, the monitoring network appliance comprising:
a programmed routine for analyzing network activity and collecting network activity information without user intervention and in real-time;
a store for storing a predefined set of rules;
a monitoring routine for screening the network activity against the predefined set of rules, and if required by the predefined set of rules, processing the network activity in accordance with the predefined set of rules; and
a programmed routine for selectively transmitting the network activity information to a mobile communications server.

24. The monitoring network appliance of claim 23, wherein the monitoring routine processes the network activity by modifying the network activity in accordance with the predefined set of rules.

25. The monitoring network appliance of claim 23, wherein the monitoring routine processes the network activity by determining whether to selectively transmit the network activity information to the mobile communications device.

26. The monitoring network appliance of claim 23, further comprising a programmed routine for receiving a command from the mobile communications device to control the network activity of the monitoring network appliance.

27. The monitoring network appliance of claim 26 further comprising a routine for updating the predefined set of rules based upon a command received from the mobile communications device.

28. The monitoring network appliance of claim 23 wherein the network activity corresponds to data packets received by the monitoring network appliance, the monitoring network appliance further comprising a routine for identifying an applicable protocol of the data packets.

29. The monitoring network appliance of claim 26, further comprising a command interpreter routine for interpreting and executing the command to control the network activity.

30. The monitoring network appliance of claim 23, further comprising a programmed routine for recording the network activity information into logs and periodically transmitting the logs to the mobile communications server.

31. The monitoring network appliance of claim 23, wherein the monitoring routine screens network activity to determine a content of the network activity.

32. The monitoring network appliance of claim 23, wherein the monitoring routine screens network activity to determine a type of the network activity.

33. The monitoring network appliance of claim 23, wherein the monitoring network appliance is configured to selectively transmit network activity information to two or more mobile communications devices.
